(19) United States
(12) Patent Application Publication
(10) Pub. No.: US 2014/0205696 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/952,845

(22) Filed: Jul. 29, 2013

(30) Foreign Application Priority Data
Jan. 24, 2013 (TW) 102102559

(51) Int. Cl. B30B 3/00; B29D 99/00

(52) U.S. Cl. CPC B30B 3/005; B29D 99/0032
USPC 425/117; 425/471; 264/212

(57) ABSTRACT

A molding roller includes a cylindrical main body and a seamless ring-shaped molding film. The main body has a smooth circumferential surface. The molding film is made of flexible organic-inorganic composite, and is coated on the circumferential surface. The molding film has a molding surface opposite to the main body. The molding surface defines a plurality of molding patterns.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metal roller. The metal roller has a circumferential surface including patterns for forming the micro structures. The pattern is formed using a laser knife. However, the metallic roller of the roll forming process has a relatively low forming efficiency.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 and FIG. 4 are flowcharts of a method for manufacturing a molding roller, according to a third exemplary embodiment.

### DETAILED DESCRIPTION

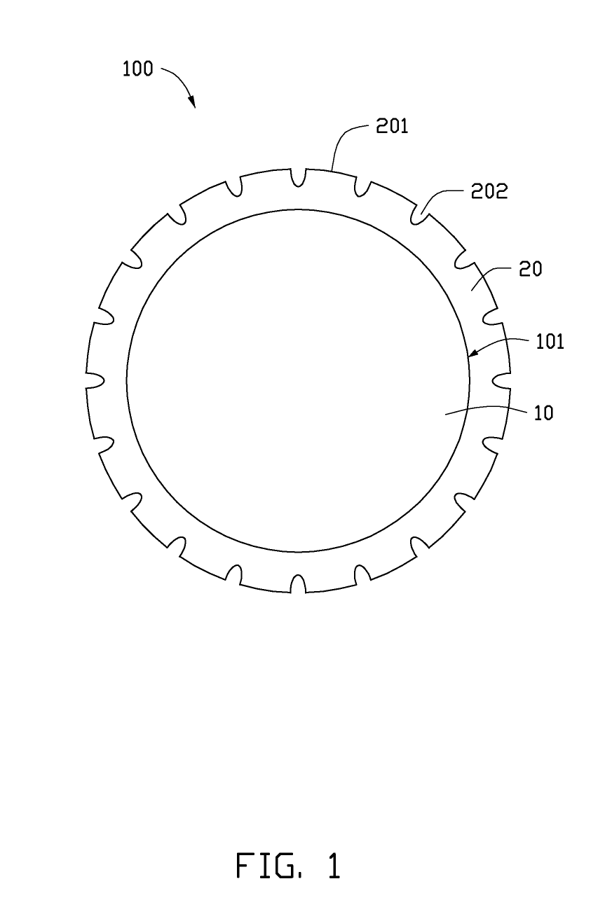

FIG. 1 illustrates a molding roller 100 accordance to a first exemplary embodiment. The molding roller 100 includes a cylindrical main body 10 and a seamless ring-shaped molding film 20 directly coated on a smooth circumferential surface 101 of the main body 10. A length of the molding film 20 is substantially equal to a perimeter of the circumferential surface 101. The main body 10 can be made of metal.

The molding film 20 includes a molding surface 201 opposite to the main body 10. The molding surface 201 defines a number of molding patterns 202. In this embodiment, the molding patterns 202 are micro-grooves.

The molding film 20 is made of flexible organic-inorganic composite. In this embodiment, the organic-inorganic composite consists of poly-ether-ether-ketone (PEEK), carbon fibers, graphite, and polytetrafluoroethylene (PTFE). The weight of the PEEK is about 70% of the total weight of the organic-inorganic composite, the sum of the weight of the carbon fiber, the weight of the graphite and the weight of the PTFE is about 30% of the total weight of the organic-inorganic composite. Because the organic-inorganic composite is easily separated from the optical films, the molding film 20 is easily separated from optical films, and the quality of the optical films can be greatly improved.

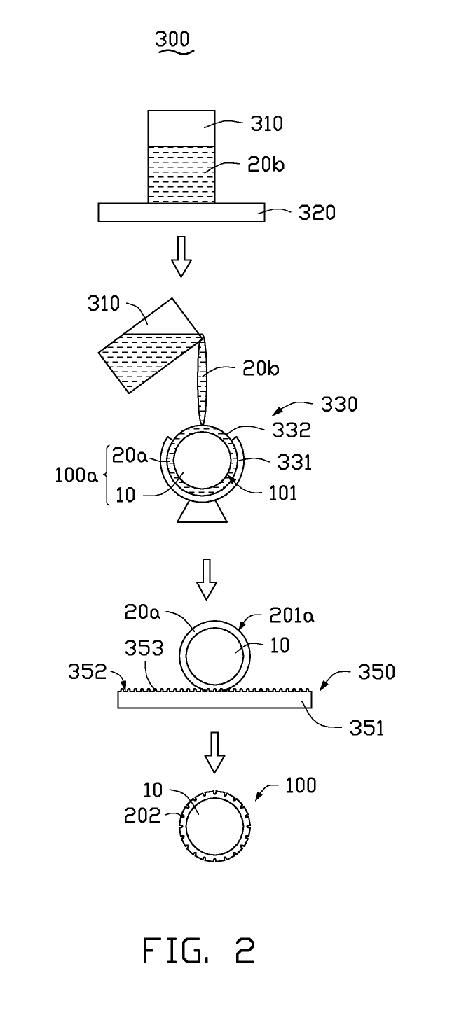

FIG. 2 shows an apparatus 300 for manufacturing the molding roller 100 according to a second exemplary embodiment. The apparatus 300 includes a container 310, a heater 320, a coater 330, and a processing device 350.

The container 310 is used for receiving a molding film material 20b. In this embodiment, the molding film material 20b is made of flexible organic-inorganic composite consisting of PEEK, carbon fibers, graphite, and PTFE.

The heater 320 is used for melting the molding film material 20b at a predetermined temperature. In this embodiment, the predetermined temperature is about 390 Celsius degrees (° C.).

The coater 330 is used for coating the melted molding film material 20b to the circumferential surface 101 of the main body 10. The melted molding film material 20b is cooled to form a seamless ring-shaped preprocessed molding film 20a. The preprocessed molding film 20a and the main body 10 cooperate to form a preprocessed molding roller 100a. The preprocessed molding roller 100a has a preprocessed molding surface 201a facing away from the main body 10. In this embodiment, the coater 330 includes a molding chamber 331. The shape of the molding chamber 331 substantially fits the shape of the molding roller 100. The main body 10 is received in the molding chamber 331, and the molding chamber 331 has an opening 332. The melted molding film material 20b is poured into the molding chamber 331 through the opening 332, and the main body 10 is rotated, and thus the melted molding film material 20b is uniformly distributed on the circumferential surface 101 of the main body 10.

The processing device 350 is used for forming molding patterns 202 on the preprocessed molding surface 201a. In this embodiment, the processing device 350 includes a metallic plate 351. The metallic plate 351 has an impression surface 352 including a number of impression patterns 353. The preprocessed molding roller 100a rotates on the impression surface 352, and the preprocessed molding film 20a is in contact with the impression patterns 353, and thus the preprocessed molding surface 201a forms molding patterns 202 mated with the impression patterns 353, and the molding roller 100 is obtained. In other embodiments, the processing device 350 can include a diamond knife or a laser knife.

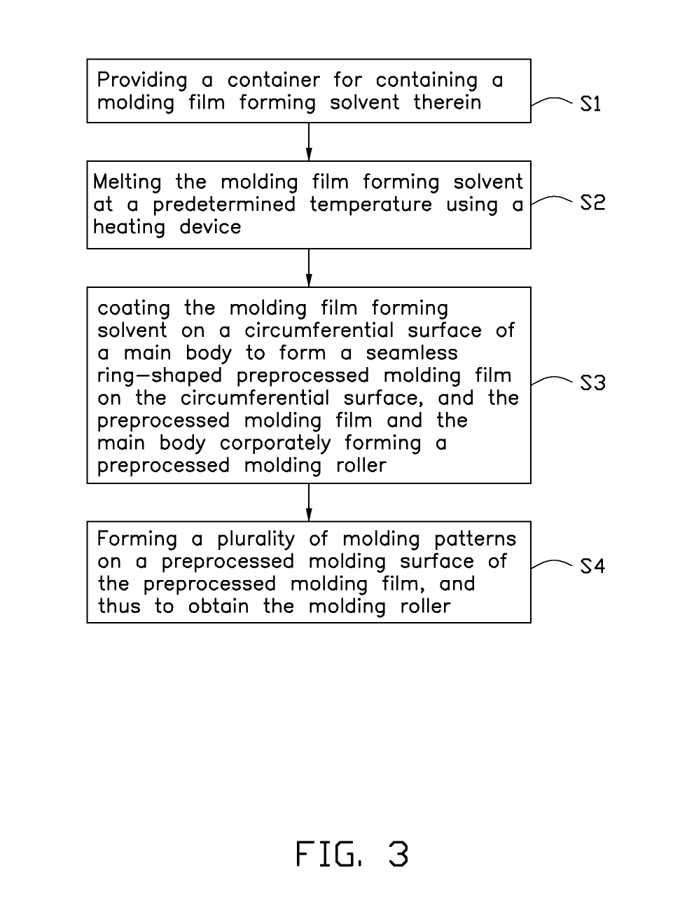

FIG. 3 shows a method for manufacturing the molding roller 100 using the apparatus 300, according to a third exemplary embodiment. The method includes the following steps.

In step S1, the container 310 is provided, and the molding film material 20b is received in the container 310.

In step S2, the heater 320 is provided, and the heater 32 melts the molding film material 20b at a predetermined temperature. In the third embodiment, the predetermined temperature is about 340° C.

In step S3, the main body 10 is received in the molding chamber 331 of the coater 330, and the melted molding film material 20b is poured into the molding chamber 331 through the opening 332, then the main body 10 is rotated, and thus the melted molding film material 20b is uniformly coated on the circumferential surface 101 to obtain the seamless ring-shaped preprocessed molding film 20a. The melted molding film material 20b and the main body 10 cooperate to form the preprocessed molding roller 100a.

In step S4, the molding patterns 202 are formed on the preprocessed molding surface 201a using the processing device 350. In the third embodiment, the processing device 350 is a metallic plate.

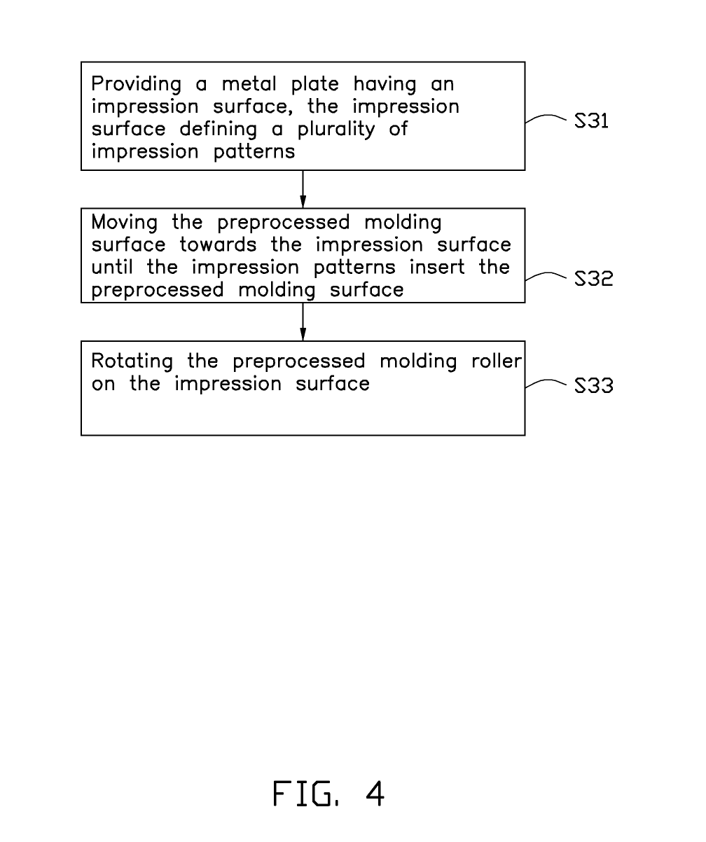

Referring to FIG. 4, the step S4 includes the following sub-steps.

In step S41, the metallic plate 351 is provided, and the metallic plate 351 has the impression surface 352 including the impression patterns 353.

In step S42, the preprocessed molding surface 201a is pushed towards the metallic plate 351 until the impression patterns 353 are inserted into the preprocessed molding surface 201a.

In step S43, the preprocessed molding roller 100a is rotated on the impression surface 352, and thus the molding patterns 202 are formed on the preprocessed molding surface 201a, and the molding roller 100 is thus obtained.

By employing the apparatus 300 and the method, the seamless molding film 20 can be directly coated on the main body 10, and the molding patterns 202 can be directly formed using the metallic pressing roller 350, therefore, the manufacturing efficiency is improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a cylindrical main body having a smooth circumferential surface; and
a seamless ring-shaped molding film coated on the circumferential surface, the molding film having a molding surface opposite to the main body, the molding surface having a plurality of molding patterns;
wherein the molding film is made of flexible organic-inorganic composite.

2. The molding roller of claim 1, wherein the organic-inorganic composite consists of poly-ether-ether-ketone, carbon fibers, graphite, and polytetrafluoroethylene.

3. The molding roller of claim 2, wherein the weight of the poly-ether-ether-ketone is about 70% of the total weight of the organic-inorganic composite, the sum of the weight of the carbon fiber, the weight of the graphite, and the weight of the polytetrafluoroethylene is about 30% of the total weight of the organic-inorganic composite.

4. The molding roller of claim 1, wherein the main body is made of metal.

5. An apparatus for manufacturing a molding roller, comprising:
a container configured for receiving a molding film material;
a heater configured for melting the molding film material;
a coater configured for uniformly distributing the melted molding film material on a circumferential surface of a cylindrical main body to form a seamless ring-shaped preprocessed molding film on the circumferential surface, wherein the coater comprises a molding chamber, the shape of the molding chamber is substantially coupled with the shape of the molding roller, the main body is received and is capable of rotating in the molding chamber, the molding chamber has an opening from which the melted molding film material flows on the circumferential surface; and
a processing device configured for forming molding patterns on a preprocessed molding surface of the preprocessed molding film to obtain the molding roller, wherein the preprocessed molding surface is opposite to the main body.

6. The apparatus of claim 5, wherein the processing device comprises a metallic plate having an impression surface, and the impression surface defines a plurality of impression patterns.

7. A method for manufacturing a molding roller, comprising:
providing a container which contains a molding film material therein;
melting the molding film material at a predetermined temperature using a heating device;
coating the molding film material on a circumferential surface of a main body to form a seamless ring-shaped preprocessed molding film on the circumferential surface, and the preprocessed molding film and the main body corporately forming a preprocessed molding roller, wherein the main body is received in a molding chamber of a coater, and the shape of the molding chamber is substantially coupled with the shape of the molding roller, the melted molding film material is poured to the circumferential surface, and the main body rotates in the molding chamber; and
forming a plurality of molding patterns on a preprocessed molding surface of the preprocessed molding film, and thus to obtain the molding roller, wherein the preprocess molding surface is opposite to the main body.

8. The method of claim 7, wherein the step of forming the molding patterns on the preprocessed molding surface comprises:
providing a metallic plate having an impression surface, the impression surface having a plurality of impression patterns;
moving the preprocessed molding surface towards the impression surface until the impression patterns insert the preprocessed molding surface; and
rotating the preprocessed molding roller on the impression surface.

9. The method of claim 7, wherein the molding film material is made of flexible organic-inorganic composite consisting of poly-ether-ether-ketone, carbon fibers, graphite, and polytetrafluoroethylene, and the predetermined temperature is about 390° C.
